(19) United States
(12) Patent Application Publication
(10) Pub. No.: US 2017/0266844 A1
(43) Pub. Date: Sep. 21, 2017

(54) Separator Device Applicable to Manual Ceramic Cutters

(71) Applicant: GERMANS BOADA, SA, RUBI (BARCELONA) (ES)

(72) Inventor: Miguel Angel SARMIENTO, RUBI (ES)

(73) Assignee: GERMANS BOADA, SA

(21) Appl. No.: 15/440,259

(22) Filed: Feb. 23, 2017

(30) Foreign Application Priority Data
Mar. 21, 2016 (ES) P201630338

(51) Int. Cl. B28D 1/22

(52) U.S. Cl. CPC B28D 1/225

(57) ABSTRACT

Separator device applicable to manual ceramic cutters, which comprises: a tilting lever (2) and an actuation cam (3) provided with a cam profile (3) with a non-uniform variation in its radius of curvature and that provides a variable relationship between the rotation of the cam and the movement of the first end of the tilting lever, depending on the rotational position of the cam, in such a way that:—when the cam (3) rotates (β1) with a certain amplitude in an initial segment of its path, the first end of the tilting lever (2) completes a movement (d1) of a certain length; and—when the cam rotates (β2), with the same amplitude as β1, but in the final segment of its path, the first end of the tilting lever (2) completes a movement (d2) that is longer than the movement (d1).

### OBJECT OF THE INVENTION

The object of the invention is a separator device applicable to manual ceramic cutters and in particular, to cutters provided with a support base for the ceramic piece and with marking means for a cutting line on the ceramic piece; said separator device comprising: a tilting lever that acts on the previously marked ceramic piece to carry out its separation into two pieces; and an actuation cam for the mentioned tilting lever.

This separator device has some construction peculiarities aimed at helping the cam transmit greater normal force to the tilting lever at the beginning of its path, making it easier to break thicker tiles, and a lesser normal force at the end of its path.

### STATE OF THE ART

Manual ceramic cutters generally comprise means for marking a cutting line on the ceramic piece and a separator device that makes it possible to apply pressure on the two portions of the ceramic piece to be separated, once this is marked, in order to break it.

Currently there are known separator devices in which the tilting lever is provided with a rotation shaft, a first end with support legs on the two pieces of the ceramic piece to be separated and a cam follower, receiver of an actuation force or push from a rotating cam with respect to the rotation shaft.

During the actuation of the cam in a certain direction of rotation, said cam transmits a force to the cam follower of the tilting lever.

The tilting lever tends to maintain itself with its first end distanced from the support base for the ceramic piece by the action of a spring, allowing ceramic pieces of different thicknesses to be introduced between said first end of the tilting lever and the base.

As the cam rotates in a certain direction, it acts against the lever follower, making the first end of the lever approach the ceramic piece to be cut.

In the existing separator devices this actuation cam has a curved profile that provides for a movement of the tilting lever proportional to the rotation angle of the cam, regardless of the position of the cam, in such a way that the relationship between the movement of the lever and the rotation angle of the cam is constant and has the same slope throughout the rotation of the cam; the cam transmitting the same force to the lever from the beginning to the end of the rotation of the lever, regardless of whether the ceramic piece to be split has a greater or lesser thickness.

Therefore, the technical problem posed is the development of a separator device, applicable to manual ceramic cutters, in which the cam transmits a force with a greater normal component in the initial phase of its path and a lesser component in the final phase, thereby varying in relation to the thickness of the ceramic piece to be cut.

### DESCRIPTION OF THE INVENTION

The separator device, applicable to manual ceramic cutters object of this invention, being of the type described previously, has some construction peculiarities, especially in relation to the cam profile, which make it possible to satisfactorily resolve the previously expounded problems; transmitting to the tilting lever a greater normal force component at the beginning of its path and a lesser force at its end.

To achieve the proposed objectives, the cam profile has a curvature that changes in a non-uniform way along the cam profile, in such a way that said cam provides a variable, downward movement of the end of the lever intended to make contact with the ceramic piece, for rotations of equal amplitude of the cam in different positions of that cam.

Specifically, the cam profile has a curvature that, for rotations of equal amplitude of the cam, provides lesser movement of the end of the lever in an initial segment of the rotation of the cam and greater movement in a final segment of the rotation of the cam. In other words, the relationship between the movement of the lever and the rotation angle of the cam is variable depending on the position of the cam and has a lesser slope in the initial segment than in the final segment of the rotation of the cam.

### DESCRIPTION OF THE FIGURES

As a complement to the description provided herein, and for the purpose of helping to make the characteristics of the invention more readily understandable, the present specification is accompanied by a set of drawings constituting an integral part of the same, which, by way of illustration and not limitation, represent the following:

FIG. 1 shows a schematic elevation view of an exemplary embodiment of the separator device applicable to manual ceramic cutters object of the invention during the partition of a thick piece of ceramic and the actuation of the cam with a first segment of the cam profile against the cam follower of the tilting lever.

FIG. 2 shows a view similar to the preceding figure during the partition of a thinner ceramic piece and the actuation of the cam with the final segment of the cam profile against the tilting lever follower.

FIG. 3 shows an elevation view of the cam of the preceding figures.

FIG. 4 shows a graph of the rotation/movement relationship of the cam of the separator device of the invention.

### PREFERRED EMBODIMENT OF THE INVENTION

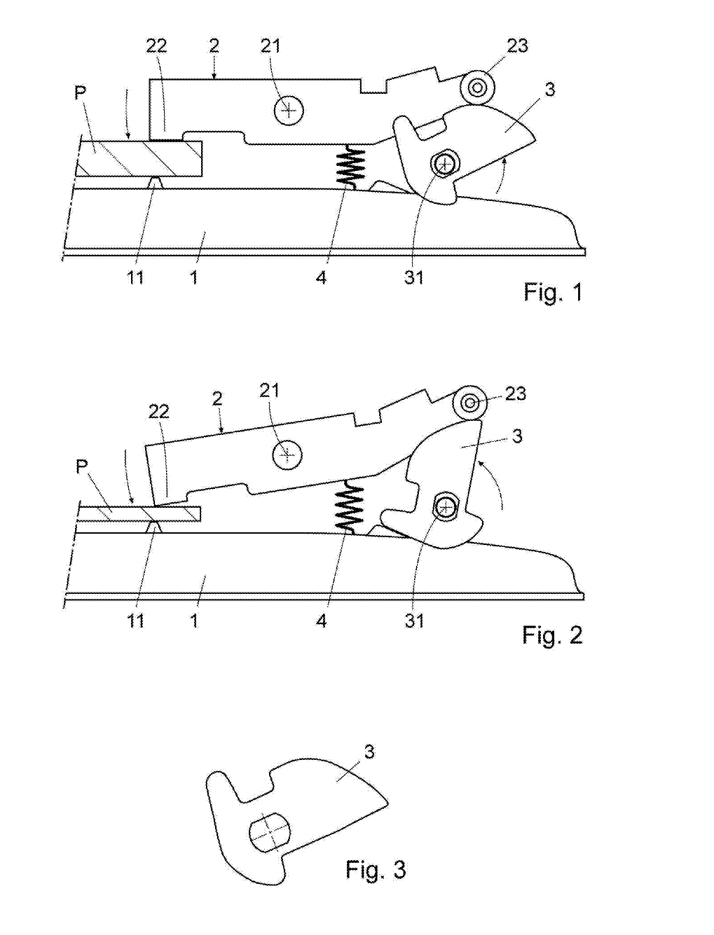

In FIGS. 1 and 2, one can schematically observe an exemplary embodiment of the separator device of the invention provided with a support base (1) for the ceramic piece (P) to be separated, said base being provided with a small protrusion (11) in the support area of the ceramic piece (P) upon which a cutting line will have been previously marked via a cutting device (not shown).

The separator device comprises a tilting lever (2) mounted on a rotation shaft (21) and an actuation cam (3).

The tilting lever (2) tends to rest in a non-operating position due to the action of a spring (4), said tilting lever (2) having a first end with support legs (22) on the portions of the ceramic piece to be separated and, on the opposite end, a cam follower (23) that is pressed against the cam profile (3) via the spring (4).

This cam (3) is mounted on a rotation shaft (31) and is actuated by a rotating actuation handle (not shown).

In FIG. 3 it can be observed that the cam profile (3) has a non-uniform variation in its radius of curvature, for which reason it provides a variable relationship between the rotation of the cam and the movement of the first end of the tilting lever, depending on the rotational position of the cam between two possible end positions of its own rotation.

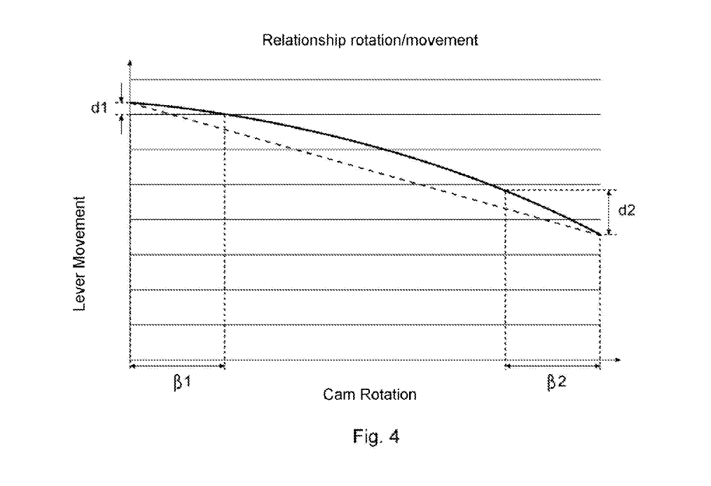

As can be seen in the graph in FIG. 4, corresponding to the relationship between the rotation of the cam and the movement of the first end of the tilting lever: - when the cam rotates (β1) with a certain amplitude in an initial segment of its path, the first end of the tilting lever (2) completes a movement (d1) of a certain length; and—when the cam rotates (β2), with the same amplitude as (β1), but in the final segment of its path, the first end of the tilting lever (2) completes a movement (d2) that is longer than the movement (d1).

This determines that the device transmits a greater force to the tilting lever (2) in the initial segment of the rotation of the cam (3), in other words, when the thicker ceramic pieces (P) are being broken; and a lesser force in the final segment of the rotation of the cam, when the thinner pieces (P) are being broken.

Having sufficiently described the nature of the invention, in addition to an example of preferred embodiment, it is hereby stated for the relevant purposes that the materials, shape, size and layout of the described elements may be modified, provided that it does not imply altering the essential characteristics of the invention claimed below.

1. Separator device applicable to manual ceramic cutters and in particular, to cutters provided with a support base (1) for the ceramic piece (P), the separator device comprising: a tilting lever (2) provided with a first end (22) and a cam (3) provided with a curved profile for actuating that tilting lever (2); characterized in that:
the cam profile (3) has a non-uniform variation in its radius of curvature and it provides a variable relationship between the rotation of the cam and the movement of the first end of the toggle lever (2), depending on the rotational position of the cam (3) between two possible end positions of its own rotation, in such a way that:
when the cam (3) rotates (β1) with a certain amplitude in an initial segment of its path, the first end (22) of the tilting lever (2) completes a movement (d1) of a certain length;
when the cam rotates (β1) with the same amplitude as (β1). in a final segment of its path, the first end (22) of the tilting lever (2) completes a movement (d2) that is longer than the movement (d1);
the device transmits a greater force to the tilting lever (2) in the initial segment of the rotation of the cam (3), in other words, when the thicker ceramic pieces (P) are bring broken; and a lesser force in the final segment of the rotation of the cam (3), when the thinner pieces (P) are being broken.
